(19) United States
(12) Patent Application Publication
(10) Pub. No.: US 2013/0242053 A1
(43) Pub. Date: Sep. 19, 2013

(54) ENDOSCOPIC APPARATUS AND METHOD FOR PRODUCING VIA A HOLOGRAPHIC OPTICAL ELEMENT AN AUTOSTEREOSCOPIC 3-D IMAGE

(71) Applicant: ABSOLUTE IMAGING LLC, Livonia, MI (US)

(72) Inventors: Hans Ingmar Bjelkhagen, Dyserth (GB); James Clement Fischbach, Birmingham, MI (US)

(73) Assignee: ABSOLUTE IMAGING LLC, Livonia, MI (US)

(21) Appl. No.: 13/886,903

(22) Filed: May 3, 2013

Related U.S. Application Data
(63) Continuation of application No. 12/408,447, filed on Mar. 20, 2009.

(51) Int. Cl. H04N 13/04

(52) U.S. Cl. CPC H04N 13/0402
USPC 348/45; 348/54

(57) ABSTRACT

A system and method for generating a three-dimensionally perceived image from a stereo endoscope by at least one viewer include an autostereoscopic display having a left projector and a right projector that project corresponding left and right images received from corresponding left and right cameras of a stereo endoscope to a holographic optical element functioning as a Bragg diffraction grating to redirect light from the left projector to a left eye-box and to redirect light from the right projector to a right eye-box for viewing by left and right eyes of a viewer to create three-dimensionally perceived autostereoscopic image without glasses or optical headgear.

### CROSS-REFERENCE TO RELATED APPLICATIONS

This application is a continuation of U.S. application No. 12/408,447 filed Mar. 20, 2009, the disclosure of which is incorporated in its entirety by reference herein.

### BACKGROUND OF THE INVENTION

1. Field of the Invention

The present disclosure relates to an apparatus and method for creating and displaying autostereoscopic three-dimensional images from an endoscope.

2. Background Art

Stereoscopic display devices separate left and right images corresponding to slightly different views or perspectives of a three-dimensional scene or object so that they can be directed to a viewer's left and right eye, respectively. The viewer's visual system then combines the left-eye and right-eye views to perceive a three-dimensional or stereo image. A variety of different strategies have been used over the years to capture or create the left and right views, and to deliver or display them to one or more viewers. Stereoscopic displays often rely on special glasses or headgear worn by the user to deliver the corresponding left and right images to the viewer's left and right eyes. These have various disadvantages. As such, a number of strategies have been, and continue to be, developed to provide autostereoscopic displays, which deliver the left and right images to corresponding eyes of one or more viewers without the use of special glasses or headgear.

Real-time medical imaging applications for diagnosis, treatment, and surgery have traditionally relied on equipment that generates two-dimensional images. For example, various types of endoscopy or minimally invasive surgery use an endoscope or similar device having a light source and camera to illuminate and provide a real-time image from within a body cavity. For some applications, special headgear or glasses have also been used to create a real-time three-dimensional view using stereo images. However, glasses or headgear may cause fatigue and/or vertigo in some individuals after extended viewing times due to visual cues from peripheral vision outside the field of view of the glasses or headgear.

### SUMMARY OF THE INVENTION

This disclosure relates to systems and methods for generating a three-dimensionally perceived image by at least one viewer. Included in one embodiment is an autostereoscopic display having a left projector and a right projector that project corresponding left and right images received from corresponding left and right cameras of a stereo endoscope through a transmissive holographic optical element (“HOE”). The HOE functions as a Bragg diffraction grating to redirect light from the left projector to a left eye-box and to redirect light from the right projector to a right eye-box for viewing by left and right eyes of a viewer to create a three-dimensionally perceived image without glasses or optical headgear.

An endoscopic viewing apparatus according to one embodiment of the present disclosure includes a tube having a light delivery system for illuminating a body cavity for inspection and at least two cameras within the tube for capturing corresponding images of the body cavity. The at least two cameras provide corresponding video signals to at least two projectors that each project a corresponding real-time image from a different angle onto a common area of one side of a transmissive holographic diffraction grating. The diffraction grating redirects incident light passing therethrough to viewing zones for each one of a viewer's eyes to create a real-time stereo image for a viewer. In a two-projector embodiment that generates two eye-boxes for a single viewer, a left projector is positioned at a first azimuthal angle relative to the holographic diffraction grating to direct a projected image corresponding to a first camera to a left eye-box and a right projector is positioned at a second azimuthal angle to direct a projected image corresponding to a second camera to a right eye-box, such that a viewer perceives a stereo image in three-dimensions unaided by special glasses, optical headgear, or the like.

Various embodiments of an endoscopic viewing apparatus according to the present disclosure may include an eye/head tracking system to move the viewing system in response to viewer movement, such that the viewer's eyes remain within corresponding left and right eye-boxes. In one embodiment a tracking system includes an emitter/detector positioned above the holographic element and in communication with a tracking computer that generates signals for a computer-controlled actuator that repositions the display system in response to viewer movement. The actuator may be implemented by a servo-controlled rotary stage, for example. The system may also include a plurality of retro-reflectors worn by the viewer to facilitate detection of viewer movement. In one embodiment, a visor having three curved non-coplanar retro-reflectors facilitates detection of viewer head movements.

One method for generating a three-dimensionally perceived image from an endoscope includes projecting substantially coextensive left and right images from corresponding left and right cameras disposed within the endoscope through a transmissive holographic diffraction grating from first and second azimuthal angles such that light projected at the first azimuthal angle is directed through the diffraction grating to a left eye of a viewer and light projected at the second azimuthal angle is directed through the diffraction grating to a right eye of the viewer. The method may also include video signal processing to combine video signals from the left and right cameras into a stereo video signal and transmitting the combined stereo video signal to an auxiliary display and/or recording the combined stereo video signal for subsequent playback. Three-dimensional viewing of the auxiliary display may include viewing aids, such as glasses, headgear, or the like, to separate or filter the left and right images for a viewer's left and right eyes.

In one embodiment, a method for generating an autostereoscopic three-dimensional image includes projecting first and second substantially overlapping images onto and through a transmissive viewing element having a holographically recorded diffraction pattern captured within a varying thickness photosensitive material, the diffraction pattern produced by an interference pattern being created by mutually coherent object and reference beams of a laser. In one embodiment, the interference pattern is captured in a master holographic plate having a photo-sensitive emulsion deposited on a substrate (such as glass or triacetate film), which is subsequently chemically processed to remove a portion of the emulsion. The remaining emulsion forms a desired master diffraction grating, sometimes referred to as a H1 hologram. The master holographic plate is then copied using known holographic techniques to a second holographic plate, sometimes referred to as a H2 hologram, which is chemically processed in a similar fashion to produce the holographic diffraction grating.

Embodiments according to the present disclosure have various associated advantages. For example, embodiments of the present disclosure provide real-time stereo images to corresponding eyes of at least one viewer to produce a three-dimensionally perceived image without viewing aids, such as glasses or headgear. The present disclosure provides real-time viewer position detection and image display synchronization to allow the viewer to move while staying within predetermined eye-boxes so that perception of the three-dimensional image is unaffected by viewer movement. Use of a transmissive holographic diffraction grating allows back illumination to facilitate packaging for endoscopic viewing applications. Transmissive holographic diffraction gratings according to the present disclosure may also provide better brightness and contrast for the viewer relative to reflection-type gratings or elements and exhibit reduced chromatic dispersion.

The above advantages and other advantages and features will be readily apparent from the following detailed description of the preferred embodiments when taken in connection with the accompanying drawings.

### BRIEF DESCRIPTION OF THE DRAWINGS

FIG. 1 is a block diagram illustrating operation of an apparatus and method for autostereoscopic display of an endoscopic image for three-dimensional perception by a viewer according to one embodiment of the present disclosure;

FIG. 2 illustrates a single-axis computer controlled actuator for positioning the display in response to viewer movement according to one embodiment of the present disclosure;

FIG. 3 illustrates a position tracking emitter and detector for use in synchronizing movement of the display with viewer movement according to one embodiment of the present disclosure;

FIG. 4 illustrates visor mountable retro-reflectors for use with the position tracking emitter and detector of FIG. 3 according to one embodiment of the present disclosure;

FIG. 5 is a partial cross-sectional view of an endoscope having at least two cameras, a light source, and imaging optics for three-dimensional viewing of an image according to one embodiment of the present disclosure;

FIG. 6 is a back view of a display system according to one embodiment of the present disclosure;

FIG. 7 is a perspective view of a display system according to one embodiment of the present disclosure;

FIG. 8 is a front perspective view illustrating a projection sub-assembly of a display system according to one embodiment of the present disclosure;

FIG. 9 is an enlarged perspective view of imaging optics for the projection sub-assembly illustrated in FIG. 8;

FIG. 10 is a back perspective view illustrating a projection sub-assembly of a display system according to one embodiment of the present disclosure;

FIG. 11 is a diagram illustrating electrical and video signal connections for a display system according to one embodiment of the present disclosure;

FIG. 12 is a flow diagram illustrating control logic for synchronizing the display system with viewer movement to provide a head tracking function of a system or method for three-dimensional image generation according to one embodiment of the present invention; and

FIG. 13 is a diagram illustrating operation of a system for making a holographic diffraction grating for a three-dimensional imaging system or method according to one embodiment of the present disclosure.

### DETAILED DESCRIPTION OF THE PREFERRED EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. The representative embodiments used in the illustrations relate generally to an autostereoscopic display system and method capable of displaying a stereo image in real-time using either live stereo video input from a stereo endoscope, or a standard video input processed to generate simulated stereo video that is perceived as a three-dimensional image by a properly positioned viewer.

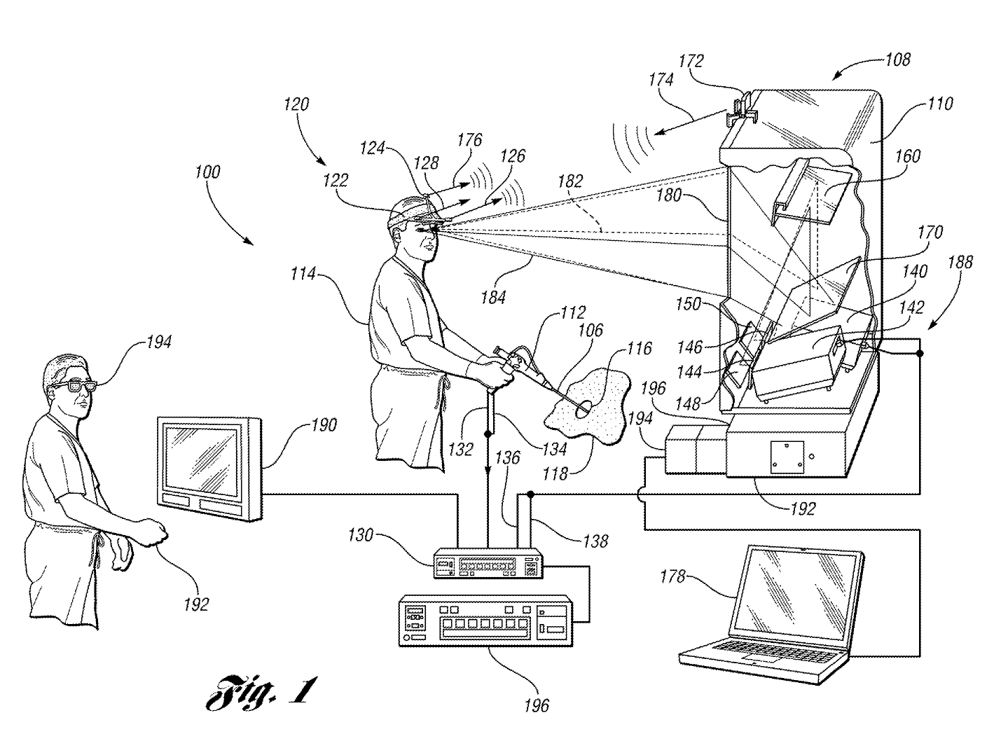

Referring now to FIG. 1, a schematic diagram illustrating an endoscopic apparatus and method for producing a three-dimensional image via a holographic optical element of an autostereoscopic display according to embodiments of the present disclosure is shown. System 100 includes a display system 110 for projecting an autostereoscopic image captured from a stereo endoscope 112 so that user 114 perceives a three-dimensional image of the interior of a cavity 116 of a body 118 or other object unaided by special glasses or optical headgear. Stereo endoscope 112 may provide left video 132 and right video 134 to a video processor 130, or directly to display system 110, depending on the particular application and implementation. Video signal processor 130 may combine or encode the stereo video signals into a multiplexed signal for display on a local or remote auxiliary screen 190 and/or for recording on a recording device 196, such as a VCR or DVD recorder, for example. Three-dimensional viewing of auxiliary display 190 by another viewer 192 may require viewing glasses 194, such as polarized or active shutter glasses depending upon the particular implementation.

In one embodiment, video processor 130 is implemented by a stereo encoder/decoder commercially available from 3-D ImageTek Corp. of Laguna Niguel, Calif. and combines the two stereo input signals into a single field-multiplexed output video signal, or vice versa. Video signal processor 130 may also include a pass-through mode where video feeds 132, 134 pass through to output feeds 136, 138 without any signal multiplexing, but may provide noise filtering, amplification, or other functions, for example, between the stereo inputs and corresponding stereo outputs.

As also shown in FIG. 1, stereo video output signal lines 136, 138 are provided to at least two associated projectors 140, 142 within enclosure 110 via a cable panel (FIG. 11). Projectors 140, 142 project corresponding images in real-time through various optical elements including lenses 144, 146 and (optionally) mirrors 148, 150, 160, 170, to focus substantially co-extensive overlapping images on, and through, transmissive holographic element 180. Holographic element 180 (sometimes referred to as a transmissive “screen” even though the resulting three-dimensional image perceived by the viewer may appear in front of and/or behind the element) may be implemented by a holographic optical element (HOE) that functions as a Bragg diffraction grating, and may therefore also be referred to as a diffractive optical element (DOE). Holographic element 180 diffracts light passing therethrough from projector 140 to a first viewing zone or eye-box 182 and light passing therethrough from projector 142 to a second viewing zone or eye-box 184. When viewer 114 is properly positioned, each eye will see only one of the images of a corresponding eye-box. The slightly different perspective provided by each image is combined by the visual processing of the viewer's brain and the viewer perceives a three-dimensional image of the interior of cavity 116 as captured by a stereo imaging system within tube 106 of stereo endoscope 112 as illustrated and described with reference to FIG. 5.

System 100 may also include a head tracking subsystem 120 that synchronizes or aligns a viewer's eyes with a stereoscopic viewing zone corresponding to the left eye-box 182 and right eye-box 184. Head tracking subsystem 120 may include means for moving eye-boxes 182, 184 in response to movement of viewer 114. In the embodiment illustrated in FIG. 1, the means for moving eye-boxes 182, 184 includes means for moving enclosure 110, which includes projectors 140, 142, lenses 144, 146, mirrors 148, 150, 160, 170, and holographic element 180, and means for detecting movement of viewer 114. The means for moving enclosure 110 may be implemented by a single or multi-axis microprocessor controlled actuator 188. In one embodiment, the means for moving enclosure 110 corresponds to actuator 188, which includes a base 192, stepper motor 194, and rotary stage 196 with stepper motor and controller 194 commanded by control logic or software executed by a computer 178. The means for detecting movement of viewer 114 may include computer 178, which communicates with motor /controller 194 and tracking emitter/detector 172 with computer 178 generating commands to rotate stage 196 in response to changes in position of viewer 114.

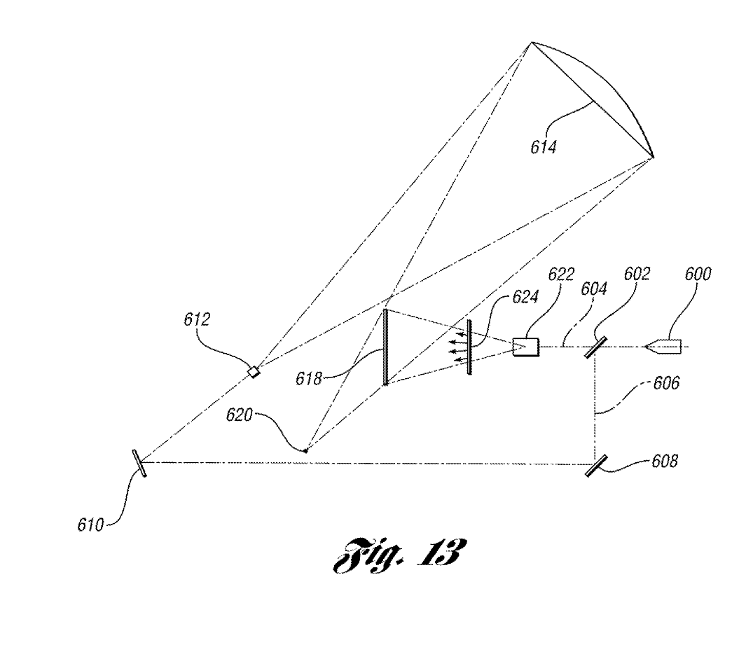

Tracking emitter/detector 172 may be mounted on enclosure 110 above holographic element 180 and emit an electromagnetic signal 174 in the direction of viewer 114. In the illustrated embodiment, viewer 114 is wearing a visor 122 having three non-coplanar retro-reflectors 124, 126, and 128 that generate a one or more reflected signals 176 indicative of the position of the head of viewer 114. The detected signal is processed by software running on head-tracking computer 178 to synchronize movement of eye-boxes 182, 184 with eyes of viewer 114. One embodiment of a head tracking synchronization function is illustrated and described in greater detail with respect to FIG. 12. In one embodiment, tracking emitter/detector 172 is implemented by the TRACKIR™ sensor commercially available from NaturalPoint, Inc. of Corvallis, Oreg.

As will be appreciated by those of ordinary skill in the art, light projected from projectors 140, 142 exits the projectors at substantially the same altitudinal angle but a different azimuthal angle, i.e. into/out of the plane of the paper. In the illustrated embodiment, commercially available projectors (Model NP-40 from NEC Corporation) are used with projector 140 mounted upside-down to provide a desired lens-to-lens distance between projector 140 and 142. These projectors are single-chip, DLP-based projectors with various embedded color correction, focusing, and keystone correction functions. Mounting one projector upside-down results in the projector housings being at different altitudinal angles, but the output lenses are positioned at substantially the same altitudinal angle as described in greater detail herein. The embedded projector processor functions are used to flip the image of projector 140, and to provide various color and keystone adjustments for both projectors 140, 142 so that the images projected on holographic element 180 are substantially rectangular and co-extensive or completely overlapping with right-angle corners. Appropriate keystone correction provides accurate depth perception for viewer 114 based on the projected stereo images.

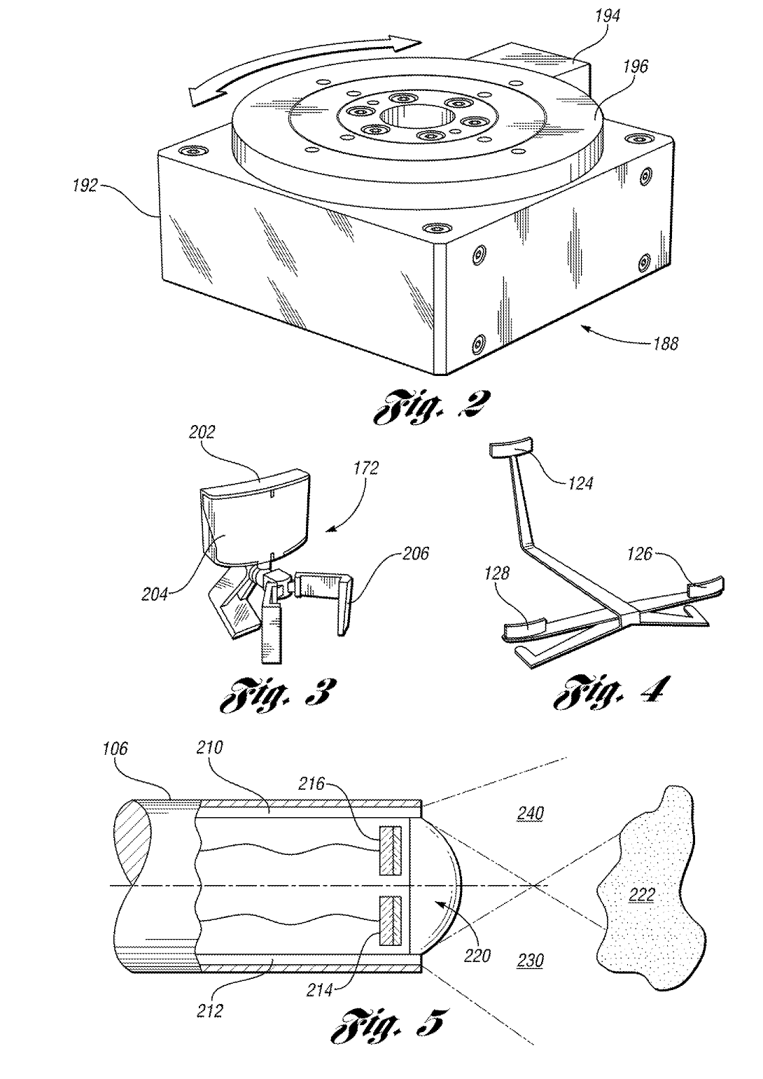

Referring now to FIG. 2, a perspective view of a representative computer-controlled actuator for use in a head tracking system of an autostereoscopic display for viewing three-dimensional endoscopic images according to the present disclosure is shown. While a single-axis actuator is illustrated, those of ordinary skill in the art will recognize that multi-axis actuators could be used to synchronize movement of eye-boxes 182, 184 with movement of viewer 114. In this embodiment, actuator 188 includes a stationary base 192 with a rotatable stage or platform 196 that may be directly-driven or belt-driven by a stepper motor/controller 194. In one representative embodiment, system 100 includes a precision rotary stage, which is commercially available from Newmark Systems, Inc of Mission Viejo, Calif. (Model RM-8).

FIG. 3 is a perspective view of a representative sensor 172 that may be used in a head tracking system 120 (FIG. 1) to detect the position of a viewer 114 according to embodiments of the present disclosure. As previously described, sensor 172 may include one or more infrared emitters and one or more infrared detectors within a curved housing 202 with an infrared filter cover 204. A standard 206 or custom mount may be used to secure sensor 172 to enclosure 110 (FIG. 1) such that sensor 172 is positioned approximately in the center of holographic element 180, and either above or below holographic element 180 such that it does not obstruct the view of viewer 114. Of course various other types of sensor(s) and sensor positioning may be used to provide a head tracking function according to the teachings of the present disclosure.

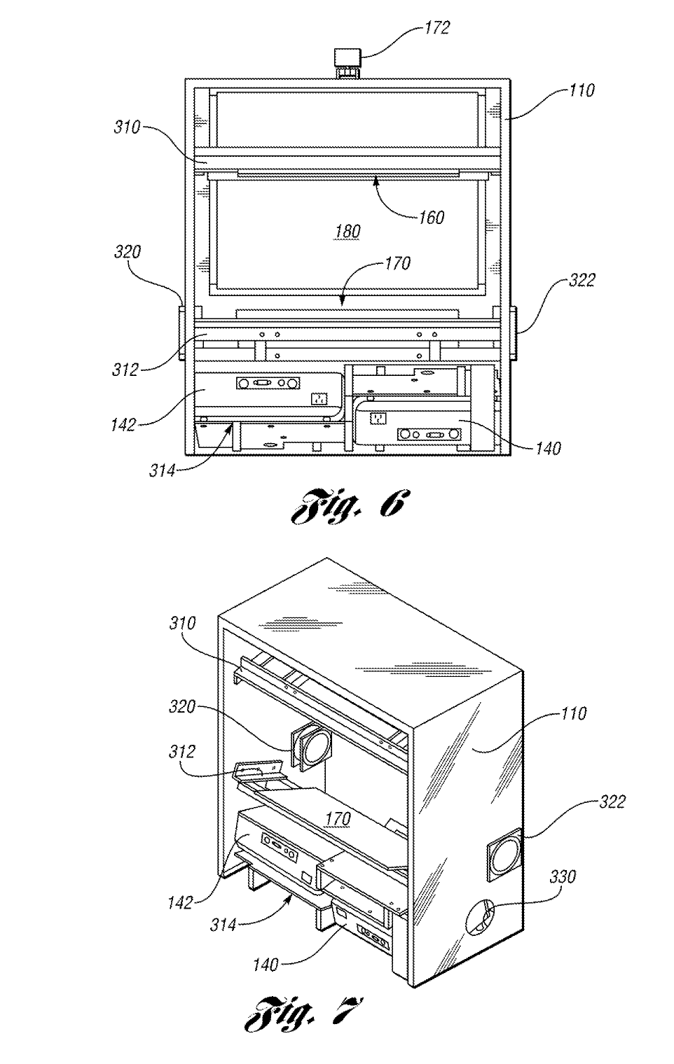

FIG. 4 is a perspective view illustrating a representative embodiment of a retro-reflector unit including three curved and non-coplanar retro-reflectors 124, 126, and 128. The retro-reflectors may be worn by, or positioned on, a viewer 114 (FIG. 1) to facilitate motion tracking as previously described. In the illustrated embodiment retro reflectors 126, 128 are spaced to correspond to an approximate average inter-pupillary distance for viewers. Of course, various other types of reflectors may be used and positioned to suit a particular application or implementation in accordance with the teachings of the present disclosure.

Referring now to FIG. 5, a partial cross-section of a representative stereo endoscope for use in embodiments of an apparatus or method according to the present disclosure is shown. Stereo endoscope 112 (FIG. 1) may include a tube 106 and an annular light delivery system optionally having one or more optic fibers 210, 212 to illuminate a distal end of tube 106 as generally represented by areas 230 and 240 for viewing of an object 222 being inspected. Light reflected from object 222 is collected and imaged by one or more cameras 214, 216 that may be optically coupled by a lens or lens system 220, which is at least partially disposed within tube 106. Lens system 220 may include a single lens or multiple optical components, such as lenses, mirrors, and the like. First camera 214 and second camera 216 may also include associated optic elements to provide corresponding focused images that are converted to video signals delivered through tube 216 via wired or wireless connections for display on display system 108 as previously described.

In one embodiment of a method according to the present disclosure, a first endoscope image is captured by first camera 214 disposed within tube 106 of endoscope 112 (FIG. 1) and transmitted to a first projector 140 (FIG. 1) for projection onto and through holographic diffraction grating 180 (FIG. 1) from a first angle to a first eye-box 182 (FIG. 1). The method also includes capturing a second endoscope image at substantially the same time as the first image with second camera 216 disposed within tube 106 of endoscope 112 (FIG. 1), and transmitting the second image to a second projector 142 (FIG. 1) for projection onto and through holographic diffraction grating 180 (FIG. 1) from a second angle to a second eye-box 184 (FIG. 1).

As illustrated in FIGS. 1-5, holographic optical element 180 is a diffractive optical element (DOE), which is a kind/class of holographic optical element (HOE) created using holographic techniques as known in the art and modified as described herein. The illustrated embodiment of system 100 incorporates a transmissive element 180 with light from at least two projectors 140, 142 shining from behind element 180 (relative to viewer 114) and passing through element 180 to corresponding left/right eye-boxes 182, 184 or viewing zones to create the image perceived as a three-dimensional image by viewer 114. Element 180 functions to diffract incident light from first projector 140 positioned at a first azimuthal angle of incidence relative to element 180 to a first eye-box 182 or viewing zone. Likewise, light from second projector 142 positioned at a second azimuthal angle of incidence relative to element 180 passes through element 180 and is diffracted toward a second eye-box 184 or viewing zone. A viewer 114 properly positioned in front of display device 108 at the viewing “sweet spot” sees only the left image 182 with the left eye and the right image 184 with the right eye. If the left image and right images are appropriately shifted one relative to the other, i.e. contain an appropriate amount of horizontal parallax, the viewer's brain combines the left and right images and the viewer 114 perceives a three-dimensional image. The horizontal parallax provides the third dimension or depth to the image, which appears in front of, within, or spanning the plane of element 180. The position of the perceived image relative to the viewing element can be controlled by appropriate positioning of the holographic plate used to create the DOE during the holographic recording process as illustrated and described with reference to FIG. 13. If viewer 14 moves out of the “sweet spot”, the three-dimensional effect is at least partially lost and viewer 14 no longer perceives a three-dimensional image.

To reduce or eliminate loss of the three-dimensional image, head tracking system 120 attempts to synchronize movement of eye-boxes 182, 184 with movement of viewer 114 to maintain alignment of a viewer's eyes with the “sweet spot” or stereoscopic viewing zone of the display. Although numerous other head/eye tracking strategies are possible, the strategy illustrated and described for above for a prototype display rotates the entire display enclosure 110 in response to viewer movement.

As previously described, the left and right video signals provided to the left and right projectors may be captured in real-time by corresponding left and right cameras positioned within an endoscope to provide appropriate parallax. Alternatively, the left and right video signals may be generated by a video signal processor, such as processor 130 (FIG. 1) or the like, that processes a standard format video input signal captured by a single camera (two-dimensional) to create a stereo left/right output signal provided to the left/right projectors by adding horizontal parallax to the left/right video output signals. As another alternative, either or both of the left/right video input signals could be based on images generated entirely by computer, i.e. CG images.

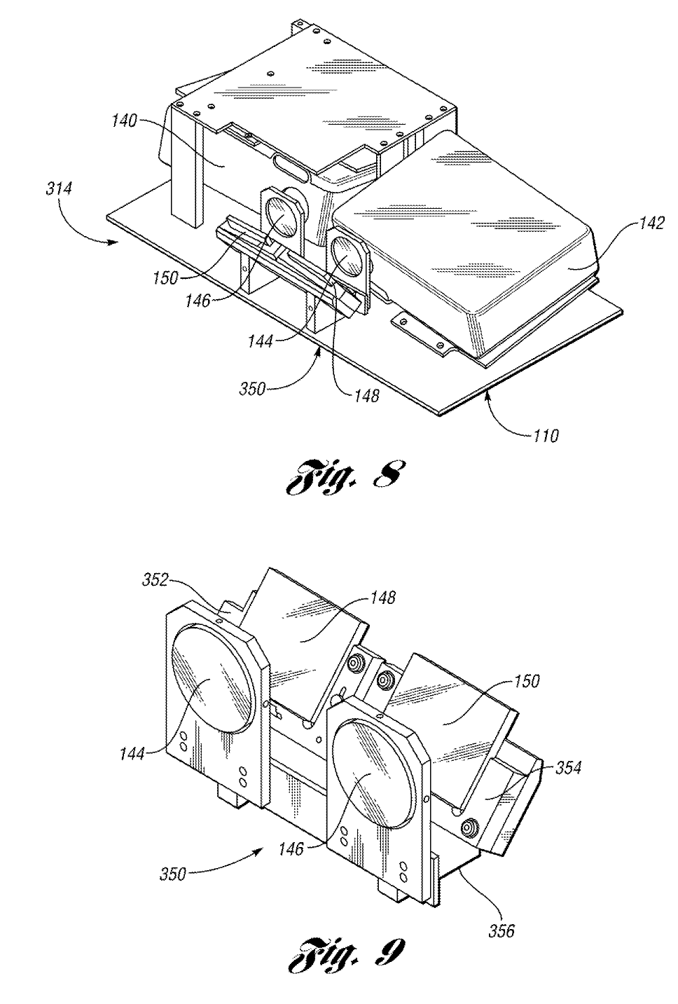

Referring now to FIGS. 6 and 7, a back view (FIG. 6) and back perspective view (FIG. 7) of a representative embodiment of a display system 108 for use in a medical imaging system 100 according to the present disclosure are shown. A back panel normally in place during operation has been removed for illustration purposes. Enclosure 110 includes a common (shared) upper mirror mount 310 for securing mirror 160 within enclosure 110. Similarly, a common (shared) lower mirror mount 312 is provided to secure lower mirror 170 within enclosure 110. In one embodiment, upper mirror mount 310 and lower mirror mount 312 are fixed mounts with angles and distances determined so that the projected images from projectors 140, 142 substantially overlap (are co-extensive) with common boundaries and completely fill holographic element 180. Of course, manually or electromechanically adjustable mounts may be used for one or more mirrors or other optical elements depending on the particular application and implementation. For example, single-axis or multiple-axis gimbal mounts may be used for one or more optical elements to adjust the angle(s) of projected light from one or both projectors 140, 142. Upper and lower mirrors 160, 170 may be positioned to match the optical path length or beam length of projectors 140, 142 to the corresponding beam length and angle selected during recording of holographic element 180 as described herein while folding the beam path to meet desired packaging constraints. As such, the number and position of optical elements used may vary by application and implementation. Upper mirror 160 and lower mirror 170 are preferably front (first) surface enhanced aluminum mirrors having a reflectivity of about 95%. In one embodiment, upper mirror 160 is about 356 mm×130 mm×3.17 mm while lower mirror 170 is about 356 mm×180 mm×3.17 mm.

In the illustrated embodiment, projectors 140, 142 are arranged to project the image through the holographic element 180 to the viewer 114 using various front-surface mirrors to fold the optical path and provide a more compact display unit. However, the optical path of the projected images may be modified for particular applications to improve aesthetics, hide the projectors from direct view, or for implementation of a display using a different HOE while maintaining a desired beam path.

Enclosure 110 may include one or more passive ventilation ports 330 that may be aligned with vents on projectors 140, and 142 to provide proper heat dissipation from enclosure 110 and manage internal operating temperatures. Enclosure 110 may also include one or more powered ventilation fans 320, 322 that may be manually or automatically controlled to manage operating temperatures of projectors 140, 142.

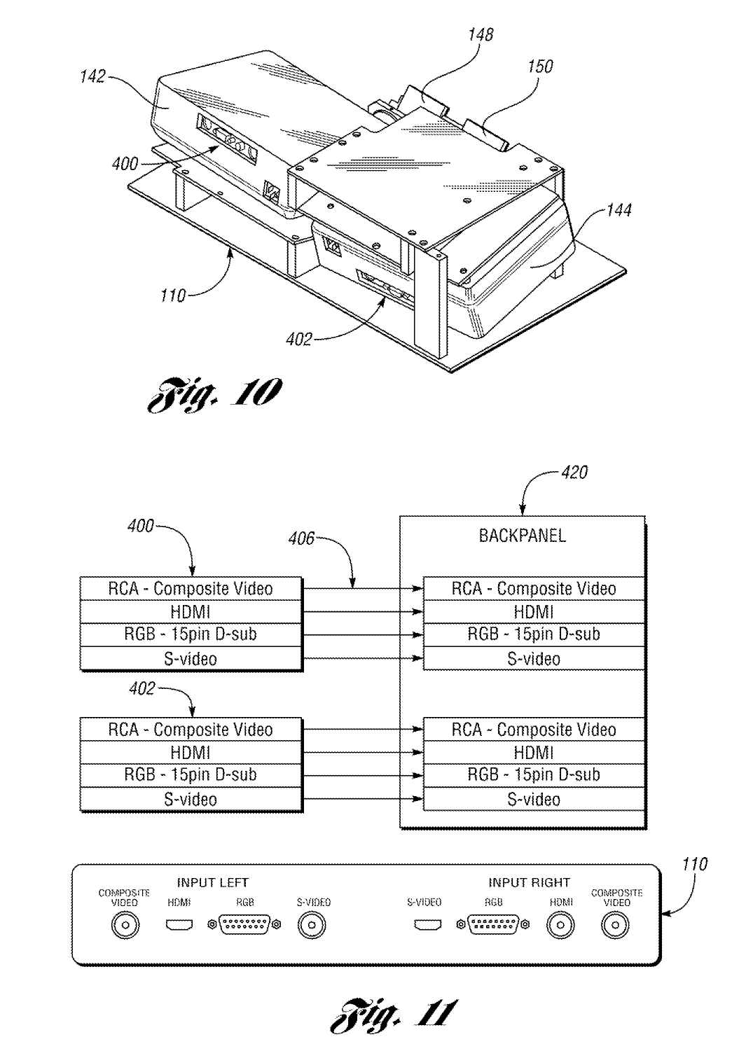

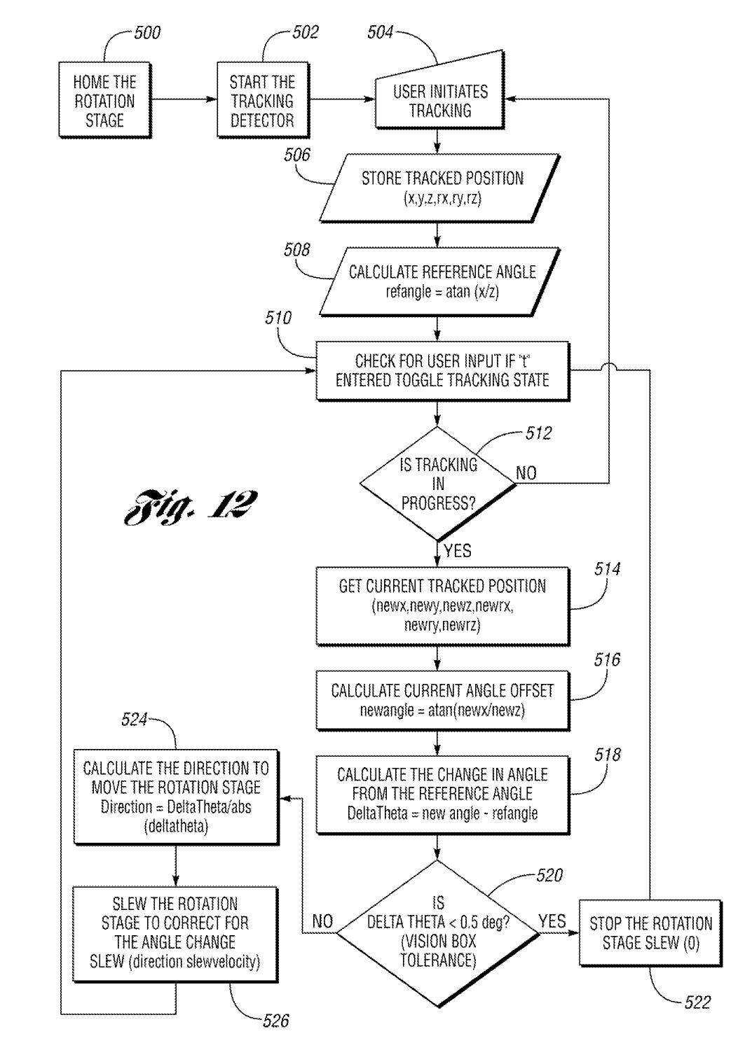

As also shown in FIGS. 6-7 and in the perspective view of FIG. 8, enclosure 110 may include a projection sub-assembly 314 to position projectors 140, 142 in a desired orientation and to secure projectors 140, 142 within enclosure 110. In the illustrated embodiment, commercially available projectors are used as previously described. As such, to achieve a desired lens-to-lens distance between first projector 140 and second projector 142, projector 140 is mounted upside-down as previously described, which requires a different orientation (angle) of the projector housing relative to the housing of projector 140 to align the corresponding projected images on the holographic element 180. In addition, the embedded projector controls are used to flip the image projected by projector 140 so it has the same (right-side-up) orientation as the image projected by projector 142. As illustrated in the front perspective of FIG. 8 and the rear perspective of FIG. 10, projector 140 is mounted upside-down with the projector housing angled generally upward relative to enclosure 110, while projector 142 is mounted right-side-up with its associated projector housing angled generally downward relative to the bottom of enclosure 110.

Projection sub-assembly 314 may optionally include projector optics 350 depending on the particular optical characteristics of the projectors and desired beam path length to achieve the desired packaging for enclosure 110. In one embodiment, projector optics 350 include a lens 144 upstream of a first mirror 148 associated with projector 142 and a lens 146 upstream of a second mirror 150 associated with projector 140. In this embodiment, lenses 144, 146 are achromatic lenses having a diameter of about 51 mm×750 mm focal length and are commercially available from ThorLabs (Model AC508-750-A1). Lenses 144, 146 are fixed in corresponding mounts and secured to adjustable mirror mounts 352, 354, which provide for independent adjustment of mirrors 148, 150, respectively.

Referring now to FIGS. 10 and 11, representative connector interfaces for projectors 142 and 144 are shown. Projector 142 includes a connector panel or interface 400 for various standardized power and video signal connectors. For example, as illustrated in FIG. 11, projectors 400, 402 may include connections for composite video signal input, high-definition (HDMI) input, component (RGB) input, and S-video input. The connector interfaces 400, 402 are connected by corresponding signal lines or cabling, generally represented by lines 406, to a back panel 420 of enclosure 110.

Referring now to FIG. 12, a block diagram illustrating operation of a viewer tracking function for use with a medical imaging system 100 according to one embodiment of the present disclosure is shown. The diagram of FIG. 12 provides a representative strategy or means for synchronizing or moving eye-boxes of an autostereoscopic display in response to viewer movement, which is sometimes referred to as head/eye tracking The illustrated blocks represent a control strategy and/or logic generally stored as code or software executed by a microprocessor of a general purpose computer. However, code or software functions may also be implemented in dedicated hardware, such as FPGA's, ASIC's, or dedicated micro-controllers in communication with sensor 172 and motor/controller 194. In general, various functions are implemented by software in combination with hardware as known by those of ordinary skill in the art. Code may be processed using any of a number of known strategies such as event-driven, interrupt-driven, multi-tasking, multi-threading, and the like depending upon the particular implementation. As such, various steps or functions illustrated may be performed in the sequence illustrated, in parallel, or in some cases omitted. Although not explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description.

Block 500 of FIG. 12 represents a zeroing or homing function for actuator 188, typically performed on a system reset or during a power-on self-test (POST) procedure so that the starting position of the actuator is known. The tracking sensor/detector 172 is then initialized as represented by block 502. The user or viewer may initiate a tracking mode via keyboard input from computer 178, for example, which results in the current position of viewer 114 being stored in memory as represented by block 506. In the embodiment illustrated, sensor/detector 172 provides a position vector having six degrees of freedom (DOF) and a vector containing x-axis, y-axis, z-axis information as well as pitch, roll, and yaw axis information (rx, ry, rz) corresponding to the detected central position between retro-reflectors 124, 126, and 128 to provide an indication of the position of the viewer's head and eyes. For the representative embodiment illustrated in FIG. 12, a reference angle is determined using only the x-axis and z-axis information by calculating the arc-tan(x/z) as represented by block 508. In block 510 keyboard input is monitored to determine whether to continue in tracking mode. The current tracking state (on or off) is toggled when appropriate keyboard input is received. Block 512 then determines whether tracking is in progress, i.e. retro-reflectors 124, 126, and 128 are detected, then tracking is in progress and control continues with block 514. If viewer 114 moves out of the field of view of sensor 172, then tracking is no longer in progress and must be re-initiated by the user as represented by block 504.

The current tracked position is obtained at block 514 with a corresponding current angle offset determined at block 516 in a similar manner as described above with reference to block 508. A delta or change in angle from the previously stored reference angle is determined as represented by block 518. If the change in angle exceeds a corresponding threshold associated with the eye-box tolerance, such as 0.5 degrees, for example, then block 524 determines the direction of rotation and generates an actuator command to rotate the stage to correct for the change of angle as represented by block 526. Control then returns to block 510.

If the change in angle is less than the corresponding threshold as determined by block 520, then the actuator is stopped as represented by block 522 and control continues with block 510.

As previously described, the viewing element in one embodiment is implemented by a transmissive HOE screen (also referred to as a transmissive DOE screen). The method or process for recording this element is generally known to those of ordinary skill in the art of holography and is described in greater detail in U.S. Pat. No. 4,799,739 to Newswanger, the disclosure of which is hereby incorporated by reference in its entirety. The process can be summarized with respect to making a transmissive holographic screen as shown in FIG. 13, which generally corresponds to FIG. 2 of the '739 patent. However, advances in various photosensitive materials developed since the '739 patent have resulted in the ability to produce more efficient transmissive HOEs with less chromatic dispersion and better contrast than previously available. As such, the process described in the '739 patent has been modified according to the teachings of the present disclosure to provide an autostereoscopic display 108 particularly suited for use in medical imagining applications, such as endoscopy, for example.

In general, as described with reference to FIG. 13, the process includes a single exposure of a master holographic plate or film 618 to create a Bragg diffraction grating for use as holographic element 180 (FIG. 1). The master holographic plate 618 captures an interference pattern created by a generally monochromatic laser 600 having a beam split by beam splitter 602 into a mutually coherent object beam 604 and reference beam 606. Reference beam 606 is steered by mirrors 608, 610, through a spatial filter 612, which expands or spreads reference beam to illuminate concave mirror 614. The reflected reference beam illuminates holographic plate or film 618 and interferes with object beam 604, which passes through a spatial filter 622 and diffuser 624 (the object) implemented by a ground glass plate before illuminating the opposite side of plate or film 618. The relative angle between the object and reference beams determines the size and position/depth of the resulting viewing zone. The entire holographic plate 618 is exposed at one time using a continuous wave (cw) laser 600 after the laser stabilizes and is operating in a single longitudinal mode (TEM_{0,0}) during the exposure. In one embodiment, a Nd:YAG laser having a frequency doubled primary line (wavelength) of 532 nm was used to create the master holographic plate. The plate was then chemically processed/developed as known in the art. A contact copy of the master holographic plate was made using known holographic techniques using the same laser operating as previously described with a frequency doubled primary wavelength of 532 nm to produce the transmissive viewing element 180 for the autostereoscopic display 108.

In general, a wide variety of materials have been used to capture/record a holographic interference pattern for subsequent use, such as photo-sensitive emulsions, photo-polymers, dichromated gelatins, and the like. The selection of a particular material/medium and corresponding recording process may vary depending upon a number of considerations. In one prototype display, the recording process described above was performed with a holographic plate including two optical quality glass (float glass) pieces each having a thickness of about 3 mm (0.125 in.) and approximately 30 cm by 40 cm in size. A silver halide emulsion having an initial thickness of about 10-12 micrometers was applied to a triacetate substrate, followed by drying and cooling, and cutting to a final size, with the coated film placed between the glass plates.

According to embodiments of the present disclosure, the photosensitive material on plate or film 618 is a nano-structured silver halide emulsion having an average grain size of 10 nm, such as the commercially available PFG-03C holographic plates, for example. Such film/emulsions/plates are commercially available from Sphere-s Co, Ltd. company located in Pereslazl-Zalessky, Russia.

Another suitable emulsion has been developed by the European SilverCross Consortium, although not yet commercially available. Similar to the PFG-03C material, the emulsion developed by the European SilverCross Consortium is a nano-structured silver halide material with an average grain size of 10 nm in a photographic gelatin having sensitizing materials for a particular laser wavelength. In general, the finer the particles, the higher efficiency and better resolution in the finished screen, but the less sensitive the material is to the laser frequency, which results in higher power density and generally longer exposure times. The photo-sensitive emulsion is sensitized using dyes during manufacturing to improve the sensitivity to the frequency doubled wavelength of the laser used during the recording process.

After the holographic plate 618 has been exposed, it is developed using generally known techniques that include using a suitable developer for fine-grain material, using a bleaching compound to convert the developed silver halide grains into a silver halide compound of a different refractive index than the surrounding gelatin matrix, and washing and drying. The emulsion and processing/developing process should be selected so that there is minimal or no shrinkage of the emulsion during processing. Depending on the particular application, a panchromatic photopolymer could be used rather than a silver halide emulsion.

After the master holographic plate has been completed, one or more copies may be made by illuminating the master plate to be copied with the same wavelength used for recording the master plate, scanning or full-beam exposure of the copy plate through master plate, and applying a developing process similar to the master plate as previously described.

The copy may also be made using a photopolymer having desired characteristics as previously described with respect to the master. The resulting master and/or copy may be coated or processed to enhance stability and durability, and/or with anti-reflective coatings to improve visibility, and the like.

As such, the present disclosure includes embodiments having various associated advantages. For example, embodiments of the present disclosure provide real-time stereo images to corresponding eyes of at least one viewer to produce a three-dimensionally perceived image without viewing aids, such as glasses or headgear. The present disclosure provides real-time viewer position detection and image display synchronization to allow the viewer to move while staying within predetermined eye-boxes so that perception of the three-dimensional image is unaffected by viewer movement. Use of a transmissive holographic diffraction grating according to the present disclosure allows back illumination to facilitate packaging for endoscopic viewing applications. Transmissive holographic diffraction gratings according to the present disclosure may also provide better brightness and contrast for the viewer relative to reflection-type gratings or elements while also exhibiting reduced chromatic dispersion.

While the best mode has been described in detail, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments discussed herein that are described as less desirable than other embodiments or prior art implementations with respect to one or more characteristics are not outside the scope of the disclosure and may be desirable for particular applications.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An endoscopic viewing apparatus comprising:
a tube;
a light delivery system at least partially within the tube for illuminating an object under inspection;
a lens system at least partially within the tube, the lens system including at least one lens;
at least one camera coupled to the at least one lens for receiving transmitted incident light;
a holographic element that redirects incident light to produce redirected incident light that is viewed by an observer;
a projector system coupled to the at least one camera, the projector system including
a first projector positioned at a first angle to direct a projected image from the at least one camera to the holographic element for viewing in a corresponding first viewing zone; and
a second projector positioned at a second angle to direct a projected image from the at least one camera to the holographic element for viewing in a corresponding second viewing zone.

2. The endoscopic viewing apparatus of claim 1 further comprising:
a head tracking subsystem that moves at least one of the holographic element and the projector system in response to movement of an observer to maintain alignment of the first and second viewing zones with the observer.

3. The endoscopic viewing apparatus of claim 2 wherein the head tracking subsystem includes a turntable for rotating the projector system and the holographic element in response to movement of the observer.

4. The endoscopic viewing apparatus of claim 1 further comprising a video signal processor that processes a standard format video input signal captured by the at least one camera to create a stereo output signal by adding horizontal parallax to images associated with the standard format video input signal.

5. The endoscopic viewing apparatus of claim 1 wherein the holographic element includes a silver halide emulsion having an average grain size of less than about 10 nm.

6. The endoscopic viewing apparatus of claim 1 wherein the holographic element comprises a panchromatic photopolymer.

7. The endoscopic viewing apparatus of claim 1 wherein the holographic element comprises a holographic plate with two optical quality glass pieces, each having a thickness of about 3 mm and edges measuring approximately 30 cm by 40 cm in size.

8. The endoscopic viewing apparatus of claim 1 further comprising:
at least three front surface mirrors positioned in an optical path between the projector system and the holographic element.

9. A method for creating a stereoscopic image of an object through an endoscope having a tube with a light delivery system at least partially within the tube for illuminating an object and transmitting reflected light therefrom, comprising:
coupling at least one camera to the light delivery system;
connecting a projector system to the at least one camera, the projector system including:
a first projector positioned at a first angle to direct a projected image from the at least one camera to a holographic element for viewing in a corresponding first viewing zone; and
a second projector positioned at a second angle to direct a projected image from the at least one camera to the holographic element for viewing in a corresponding second viewing zone.

10. The method of claim 9 further comprising:
rotating the first and second projectors in response to movement of a user to maintain alignment of the first and second viewing zones with eyes of the user.

11. The method of claim 9 further comprising:
processing images from the at least one camera to add horizontal parallax.

12. The method of claim 9 wherein the holographic element comprises a glass plate having a silver halide emulsion with grain size of less than about 10 nm.

13. An autostereoscopic display system comprising:
an enclosure;
a transmissive holographic optical element made with a photosensitive medium including an emulsion of gelatin and fine grain silver halide particles exposed to a mutually coherent reference beam and object beam having a selected wavelength, the reference beam being positioned at a first altitudinal angle of 45+/−2 degrees and a first azimuthal angle of about zero degrees relative to the photosensitive medium, the object beam passing through a diffuser tilted at an achromatic angle prior to combining with the reference beam on the photosensitive medium to create an interference pattern recorded in the photosensitive medium, the object beam positioned at a second altitudinal angle of about zero degrees (perpendicular) and a second azimuthal angle of about zero degrees, the photosensitive medium being positioned about 40-60 cm relative to a datum plane selected from the group consisting of the focal point, the Fourier plane, and an exit pupil of a mirror/lens subsystem;
a first projector positioned to illuminate an area within a first surface coated mirror secured within an adjustable mount and positioned to reflect light from the first projector toward a second surface coated mirror secured within an adjustable mount, to illuminate the transmissive holographic optical element at a third altitudinal angle of about 45 degrees and a third azimuthal angle;
a second projector positioned to illuminate an area within a third surface coated mirror positioned to reflect light from the second projector toward the second surface coated mirror to illuminate the transmissive holographic optical element at a fourth altitudinal angle and a fourth azimuthal angle;
wherein the second surface coated mirror is positioned to reflect light originating from the first and second projectors and reflected by the first and third surface coated mirrors to illuminate the transmissive holographic optical element.

14. An apparatus for generating an autostereoscopic image, comprising:
a stereo endoscope with left and right cameras;
a transmissive holographic optical element; and
an autostereoscopic display having a left projector and a right projector that project corresponding left and right images received from the corresponding left and right cameras of the stereo endoscope through the transmissive holographic optical element to redirect light from the left projector to a left eye box and to redirect light from the right projector to a right eye box for viewing by left and right eyes of an observer.

15. The apparatus of claim 14, further comprising:
a head tracking system having a computer controlled actuator that moves the autostereoscopic display in response to observer movement such that the observer's eyes remain within corresponding left and right eye boxes; and
an emitter/detector positioned above the holographic optical element and in communication with a tracking computer that generates signals for the computer controlled actuator to move the display in response to observer movement.
